(19) United States
(12) Patent Application Publication
(10) Pub. No.: US 2024/0050903 A1
(43) Pub. Date: Feb. 15, 2024

(54) METHOD FOR CLEANING A FILTER MODULE, AND FILTER MODULE FOR CARRYING OUT SAID METHOD

(71) Applicant: FRESENIUS MEDICAL CARE DEUTSCHLAND GMBH, Bad Homburg (DE)

(72) Inventors: Thomas HEINZ, St. Wendel (DE); Sven REITER, St. Wendel (DE); Wehmeyer WOLFGANG, Tubingen (DE); Gerhard WIESEN, Bad Homburg (DE)

(73) Assignee: FRESENIUS MEDICAL CARE DEUTSCHLAND GMBH, Bad Homburg (DE)

(21) Appl. No.: 18/268,249

(22) PCT Filed: Dec. 21, 2021
(86) PCT No.: PCT/EP2021/087132

§ 371 Date: Jun. 19, 2023

(30) Foreign Application Priority Data
Dec. 21, 2020 (DE) 10 2020 134 427.9

(51) Int. Cl. B01D 65/02

(52) U.S. Cl. CPC B01D 65/027; B01D 2313/21; B01D 2321/20

(57) ABSTRACT

A method is disclosed for cleaning a filter module by means of a filter module having the following steps: providing a filter module having a filter head with two filter head openings; channelling fluid into the filter head via a first filter head opening; and channelling a portion of the fluid out of the filter head via a second filter head opening. The method is characterized in that, after fluid has been channelled into the filter head (210) via a first filter head opening, the fluid is partially swirled in the filter head.

### FIELD OF THE INVENTION

The invention relates to a method for cleaning a filter module and a filter module for carrying it out.

### STATE OF THE ART

Filter devices for filtering fluids in which fluid to be filtered—this is called raw fluid in the following—is carried to the filter have the following disadvantage in particular in continuous operation. In areas in which the feed flow is less strongly developed—these are called dead volumes in the following—deposition of foreign particles increasingly occurs. Due to the functional principle, these deposits are enlarged by further foreign particles as the filter process proceeds, whereby the dead volume is also enlarged. Furthermore, the filter inlet is also clogged with foreign particles. The filter process is thereby made increasingly difficult and ultimately becomes inefficient. The foreign particle deposits can be removed by cleaning the filter devices. In order to counteract this and to be able to constitute a continuous filter operation for industrial purposes in terms of maximum machine efficiencies, it is advantageous to minimize filter-cleaning times. In order to maintain a continuous filter operation despite occasional outage of a filter, several filter modules can be used in parallel, which feed filtrate into a central header pipe. At the same time, the quantity of filtrate can be increased thereby. Various filter systems are known which, for example for industrial purposes, filter fluids and discharge the filtered fluid again. Such a filter system is disclosed for example in WO 2013/048801 A1. This comprises a filter module arrangement which comprises a container with a filtration cartridge arranged in it and a header coupled to one end of the container, wherein the head contains a housing with an open upper end and a lower end as well as an end cap. A portion which fits a complementary structure, which is defined by the inside of the entire open upper end of the housing, so that it engages removably with the housing and the end cap, defines a passageway through which liquid can flow out of the container. The filter module arrangement makes a manifold arrangement possible, which is used to convey liquids to and from a filter system which comprises several such modules. However, disadvantages of existing solutions for filter cleaning are that they are based on the principle of backwashing, thus the complex reversal of the flow direction and the use of filtrate to wash the filters against the main filter direction. For this, the filter process must be interrupted and contaminated fluid must be removed and disposed of. These complex cleaning steps reduce the efficiency of the filter process and increase the costs of the filter process.

### Presentation of the Invention

The object of the invention is to provide a cleaning method, and a filter module for carrying it out, with which the filter module can be cleaned efficiently and cost-effectively. The fluid to be filtered is preferably a liquid, in particular water.

This object is achieved by a method according to claim 1 and a filter module according to claim 10. Further features developing the invention are contained in the dependent claims. The dependent claims can be combined with each other in a technologically meaningful manner.

The first, second and third axes, to which reference is made in the following, are arranged such that the second axis is arranged perpendicular to the first axis and the third axis is arranged simultaneously perpendicular to the first axis and to the second axis.

A method according to the invention for cleaning a filter module by means of a filter module has the following steps. First, a filter module having a filter head with two filter head openings is provided. Then, fluid is channelled into the filter head via a first filter head opening. A portion of the fluid is then channelled out of the filter head via a second filter head opening. The method is characterized in that, after fluid has been channelled into the filter head, the fluid is partially swirled in the filter head. Swirling the fluid in the filter head results in the advantage that an intense fluid flow is developed in a large part of the filter head, whereby the dead volume is minimized. This also means that deposits of foreign particles are minimized. Because a portion of the fluid is channelled out of the filter head, foreign particles present in the fluid are continuously channelled out of the filter head with it. The deposition and attachment of foreign particles are likewise minimized thereby.

The channelling of the fluid can be effected with the aid of fluid lines in the simplest case. The movement of the fluid can be generated for example with the aid of a pump for liquids and with the aid of a compressor for gases. The line control can be effected for example with the aid of valves and/or a valve device with control unit. The descriptions first filter head opening and second filter head opening belonging to the filter head openings only relate to the method step carried out with the respective filter head opening. Therefore, it is likewise possible to arrange the filter module such that the formerly second filter head opening is now used as first filter head opening, and vice versa.

The swirling of the fluid in the filter head can be effected substantially continuously about an axis of rotation parallel to the third axis. Thus, a flow which is constant substantially within a plane spanned by the first axis and second axis is generated. In addition, it is possible for the swirling of the fluid also to be effected such that a flow or partial flow forms in which fluid is also moved along the third axis. In the case of such a swirling, it is made possible also to remove such foreign particles which have settled on ends of the filter head located along the third axis. It is also possible for the swirling of the fluid to be effected such that smaller, unsteady swirls are formed in the flow edge area, thus at the wall of the filter head. In the case of such a swirling, foreign particles are more strongly impeded from attaching to the wall of the filter head.

A targeted swirling of the fluid in the filter head can be achieved by any flow-altering structural geometry elements. These can be for example cross-section changes, corners or edges. Suitable structural geometry elements can be for example round, rounded or pointed.

The strength of the swirling of the fluid can also be controlled by the general flow speed, thus the rate at which fluid is introduced. A more intense swirling of the fluid can be achieved if the flow speed is increased, and vice versa.

In addition to the removal of foreign particles by the swirling of the fluid, foreign particles are also carried out of the filter head by the linear flow of the fluid. The linear portion of the flow and the swirled portion thereof function in a mutually complementary or synergistic manner. Thus, for example, foreign particles which are present in the swirled portion of the flow can pass into the linear portion thereof and be continuously channelled out of the filter head with it.

In one design, the filter module furthermore has a filtrate area and, before one portion of the fluid is channelled out of the filter head via a second filter head opening, another portion of the fluid is channelled from the filter head into the filtrate area.

Thus, it is made possible, in addition to cleaning the filter module, to also use it to filter fluid.

In one design, after the fluid has been channelled into the filter head via a first filter head opening and before the fluid is swirled in the filter head, the fluid is accelerated along a path connecting the filter head openings.

Thus, an intense swirling of the fluid is made possible.

The path on which the acceleration takes place can be a straight line in the simplest case. In addition, any path shapes which at least do not disadvantageously counteract an acceleration are suitable. Accordingly, among others, elliptical or hyperbolic path shapes and other continuous curves are also suitable.

The acceleration of the fluid can, among other things, be caused by geometrical means, for example by a narrowing of the cross section, or by an increase in the pressure, for example by means of a pump or by means of a compressor.

In one design, the filter head furthermore has two filter head parts separated from each other in a fluid-impermeable manner and, while fluid is being channelled into the filter head via a first filter head opening, fluid is channelled both into a first filter head part and into a second filter head part.

Thus, a plurality of further cleaning and filtration steps are made possible.

The filter head parts are deemed to be fluid-impermeable according to the invention, among other things, when they are hermetically sealed, but also when they are substantially—thus almost—sealed.

The descriptions first and second belonging to the filter head parts only relate to a sequence applied in the method step carried out. Therefore, it is likewise possible to carry out the method such that the formerly second filter head part is now used as first filter head part, and vice versa.

In one design, the filter module furthermore has a second filter head with two filter head openings; while fluid is being channelled into the first filter head via a first filter head opening, fluid is channelled into the second filter head via a first filter head opening of the second filter head; after fluid has been channelled into the second filter head via a first filter head opening, the fluid is partially swirled in the second filter head; and, while a portion of the fluid is being channelled out of the first filter head via a second filter head opening, a portion of the fluid is channelled out of the second filter head via a second filter head opening of the second filter head.

Thus, a plurality of further cleaning and filtration steps are made possible.

In one design, after being channelled out, the portion of the fluid channelled out of a filter head is channelled into a filter head again via a first filter head opening. In the simplest case, the fluid can be fed as recirculation back to the filter head out of which it has previously been channelled.

Thus, it is made possible to use the fluid again for cleaning and/or as raw fluid for filtration after it has been used for cleaning and/or as raw fluid for filtration.

In one design, while a first filter module having a filter head with two filter head openings is provided, a second filter module having a filter head with two filter head openings is provided. Furthermore, after a portion of the fluid has been channelled out of a filter head of the first filter module via a second filter head opening, the fluid channelled out of a filter head of the first filter module is channelled into the filter head of the second filter module via a first filter head opening of the filter head of the second filter module. Then the fluid is partially swirled in the filter head of the second filter module. A portion of the fluid is then channelled out of the filter head of the second filter module via a second filter head opening of the filter head of the second filter module.

Thus, it is made possible to carry fluid through two or more than two filter modules one after another. In this way, it is made possible to use the same fluid multiple times for cleaning and/or as raw fluid for filtration.

In one design, after it has been channelled out of the filter head of the second filter module, the fluid is channelled into a filter head again via a first filter head opening.

Thus, it is made possible to use the fluid again for cleaning and/or as raw fluid for filtration after it has been used for cleaning and/or as raw fluid for filtration. This re-use of already used fluid in a recirculation can take place as often as desired in succession. The foreign particles content in the fluid introduced increases with every new recirculation. To guarantee the necessary process stability, therefore, it can be necessary to drain off, thus to dispose of, a portion of the fluid with a high concentration of foreign particles. Thus the proportion of freshly introduced fluid increases, whereby the proportion of foreign particles falls.

In one design, the second filter module furthermore has a second filter head with two filter head openings and, after a portion of the fluid has been channelled out of a filter head of the first filter module via a second filter head opening, the fluid channelled out of a filter head of the first filter module is channelled into the second filter head of the second filter module via a first filter head opening of the second filter head of the second filter module. Then the fluid is partially swirled in the second filter head of the second filter module. A portion of the fluid is then channelled out of the second filter head of the second filter module via a second filter head opening of the second filter head of the second filter module. After it has been channelled out of the second filter head of the second filter module, the fluid is then channelled into a filter head again via a first filter head opening.

Thus, it is made possible for several filter heads of the second filter module to be involved in the method in parallel.

A further aspect of the invention relates to a filter module having a filter head with two filter head openings. The filter module is characterized in that a first filter head opening and a second filter head opening are arranged one behind another along a first axis, wherein the first axis runs through the centre of the first filter head opening and through the centre of the second filter head opening. The filter module is furthermore characterized in that an inner filter head cross section located perpendicular to the first axis along the first axis starting from the first filter head opening first gets bigger along the second axis and then gets smaller up to the second filter head opening along the second axis. The filter module is furthermore characterized in that at its ends located along the second axis and at a first of its two ends located along the third axis the filter head is closed, and at a second of its ends located along the third axis the filter head has an opening.

Thus, it is made possible to carry out the above method for cleaning a filter module by means of a filter module.

The descriptions first and second belonging to the filter head openings and further components only relate to an arrangement of the respective filter head opening or component. Therefore, it is likewise possible to arrange the filter module such that the formerly second filter head opening is now used as first filter head opening, and vice versa. In further designs, it is also possible for a filter module to have several first filter head openings or first similar components and several second filter head openings or second similar components. The flexibility of the filter head is thus increased, and it can be used more universally for a larger number of different filter and filter-cleaning processes.

In one design, the filter module is aligned such that the first axis and the second axis lie in a substantially horizontal plane.

The details along an axis or in a plane mean, with respect to the arrangement and alignment of components of the filter module, that these are arranged or aligned parallel to the reference axis or reference plane with or without spacing. Parallel means substantially parallel, with a deviation of at most 10%. This deviation can be continuous, thus in the sense of an angular deviation. However, it can also be discontinuous, thus can be smaller or larger in part.

The opening arranged at a second end of the filter head located along the third axis can extend completely over the entire cross section parallel to the plane spanned by the first axis and second axis. The opening can, however, also extend only over portions of the named cross section. The opening is particularly preferably formed such that the fluid, when it is channelled from the filter head into a filtrate area via the opening, is carried exclusively into filter elements, thus no fluid is channelled past the filter element unfiltered. This can in particular be achieved in that the opening is adapted to the associated filter element or the associated filter elements. It is also possible to connect the filter element or the filter elements tightly to the opening, for example through a sealed releasable connection, such as a screw connection, or through the moulding of the filter element or the filter elements into the opening. It is also possible for the filter head to have several openings.

In one design, the inner edge of the filter head runs partially elliptically in the plane spanned by the first axis and the second axis.

An elliptical shape or an elliptical course is defined, with reference to the above-described inner edge of the filter head and with reference to further shapes or courses described in the following, as any shape or any course which has radial, toroidal and/or elliptical portions. These are also taken to mean shapes and courses which deviate slightly from the ideal geometric shapes or courses.

Thus, it is made possible for a portion of the flow to run in a laminar manner. In this way, a continuous in- and outflow of fluid is made possible.

In one design, the filter head cross section along the first axis first gets smaller along the second axis before its increase in size taking place along the second axis.

Thus, it is made possible for the fluid to be accelerated before a portion thereof is swirled.

The described reduction in size of the filter head cross section and also further reductions in size thereof described in the following can run continuously, but also in part have an increase in size, if the input cross-sectional area is larger than the output cross-sectional area.

In one design, the inner edge of the filter head runs partially elliptically in the plane spanned by the first axis and the second axis in the area of the reduction in size of the filter head cross section, which takes place before the increase in size thereof taking place along the second axis. The elliptical shape is defined according to the corresponding definition above.

Thus, it is made possible for the flow to be accelerated substantially in the main flow direction.

In one design, the filter head cross section first gets smaller along the first axis starting from the first filter head opening along the third axis and then gets bigger up to the second filter head opening along the third axis.

The described increase in size of the filter head cross section and also further increases in size thereof described in the following can run continuously, but also in part have a reduction in size, if the input cross-sectional area is smaller than the output cross-sectional area.

Thus, it is made possible to leave the size of the cross-sectional area of the filter head in the described area substantially unchanged, thus to compensate for a reduction in size along one axis by an increase in size along another axis. As a result, the fluid speed is not affected during use of the filter module. In this way, the introduction of swirls is promoted.

In one design, the inner edge of the filter head runs partially elliptically in the area of the reduction in size taking place along the third axis.

Thus, it is made possible for a portion of the flow to run in a laminar manner. In this way, a continuous in- and outflow of fluid is made possible.

In one design, the filter head furthermore has two filter head parts, wherein the filter head parts each extend from the first filter head opening up to the second filter head opening, and the filter head parts are separated from each other in a fluid-impermeable manner along the first axis between the first filter head opening and the second filter head opening. The fluid-impermeable separation can be formed, among other things, by means of separate separating elements, but also by corresponding bulges, protrusions or walls of the filter head.

Thus, it is made possible to carry out the above-described designs of the method for cleaning a filter module by means of a filter module relating to fluid-impermeable filter head parts. The correspondingly described definitions and technical effects likewise apply here.

In one design, the filter module furthermore has a filtrate area, wherein the filtrate area is connected to the filter head at the second end of the filter head located along the third axis. The filtrate area can have one filter element or several filter elements. These are preferably membrane filters and particularly preferably hollow fibre membrane filters.

Thus, it is made possible, in addition to the use of the filter module within the framework of filter-cleaning methods, to also use it to filter fluids.

In one design, the filter module furthermore has a second filter head equivalent to the first filter head, wherein the filtrate area is connected to the second filter head at the second end of the second filter head located along the third axis. A second filter head equivalent to a first filter head is preferably similar and particularly preferably identical to the first filter head. The second end of the second filter head located along the third axis corresponds to the end having the opening.

Thus, it is made possible to channel fluid into the same filtrate area via several filter heads of the same filter module.

In one design, the closed end of the filter head is formed dome-shaped along the third axis.

The closed end of the filter head is deemed to be dome-shaped even when only parts thereof are formed as a dome or as part of a dome. All curved shapes with a single apex are deemed to be dome-shaped.

A further aspect of the invention relates to a filter module arrangement consisting of at least two filter modules. The filter module arrangement is characterized in that the filter modules are arranged one behind another and connected to each other such that fluid can be channelled first into a filter head of a first filter module and then into a filter head of a second to n-th filter module.

Thus, it is made possible to arrange several filter modules one behind another.

### BRIEF DESCRIPTION OF THE FIGURES

FIG. 1a shows a schematic representation of a filter module arrangement according to the invention for cleaning a filter module as a sectional view in a plane spanned by a first axis and a second axis.

FIG. 1b shows a schematic representation of a method according to the invention for cleaning a filter module as a sectional view in a plane spanned by a first axis and a third axis.

FIG. 2a shows a schematic representation of a filter head of a filter module according to the invention with flow lines as a sectional view in a plane spanned by a first axis and a second axis.

FIG. 2b shows the filter head represented in FIG. 2a with two filter head parts and with flow lines.

FIG. 2c shows the filter head represented in FIG. 2a with two filter head parts and with filter head cross sections.

FIG. 3a shows a schematic representation of a filter head of a filter module according to the invention with flow lines as a sectional view in a plane spanned by a first axis and a third axis.

FIG. 3b shows the filter head represented in FIG. 3a with filter head cross sections.

FIG. 4a shows a schematic representation of a filter module according to the invention in a plane spanned by a first axis and a third axis.

FIG. 4b shows a schematic representation of a filter module arrangement according to the invention in a plane spanned by a first axis and a third axis.

FIG. 5 shows a schematic representation of a filter head of a filter module according to the invention as a sectional view in a plane spanned by a second axis and a third axis.

### DESCRIPTION OF THE PREFERRED EMBODIMENTS

The following description is by its nature merely illustrative. For the sake of clarity, the same reference numbers are used to identify similar elements in the figures. It is to be noted that some steps within a method can be carried out in a different sequence, without altering the principles of the present disclosure.

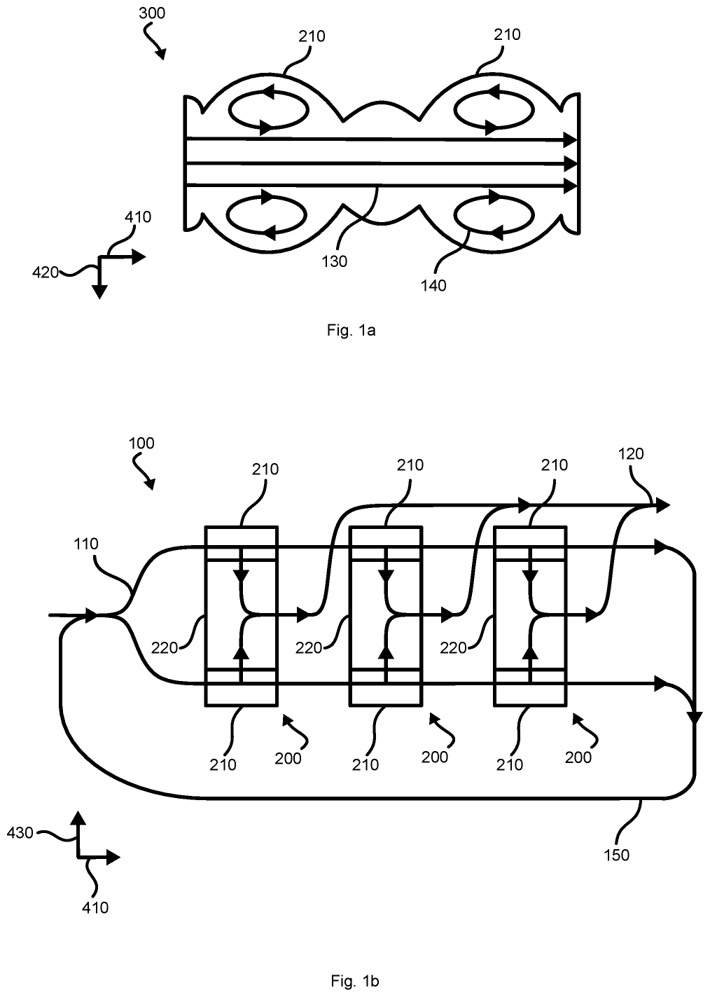

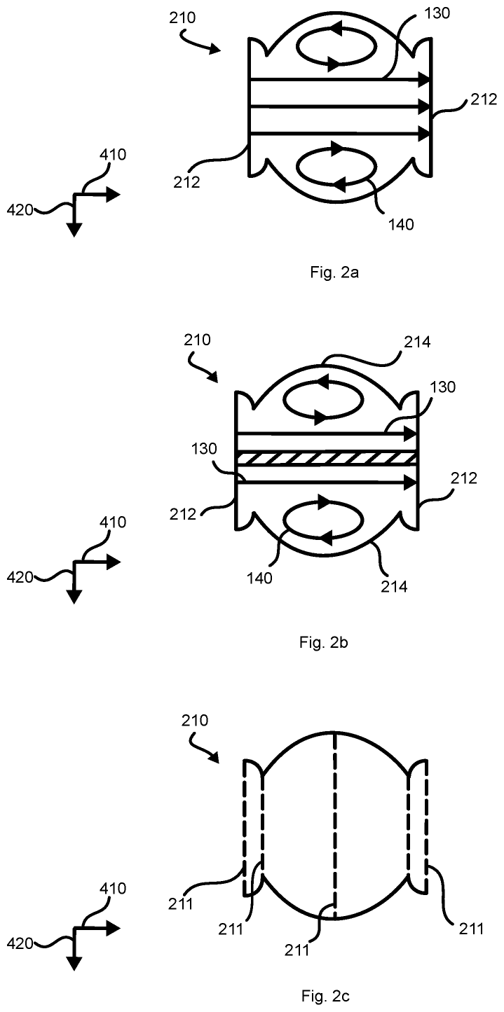

A filter module arrangement 300 according to the invention is represented schematically in FIG. 1a as a sectional view in a plane spanned by the first axis 410 and the second axis 420. Two filter heads 210 arranged one behind another in relation to the first axis 410 are represented, which each belong to separate filter modules 200. The fluid flow is represented by means of the arrows running through the filter heads 210. The main flow 130, which is represented by horizontal arrows, runs along the first axis 410. Along the second axis 420, at a distance from the main flow 130 and in the areas of the filter head 210 which form and disappear again due to the increase in size and subsequent reduction in size of the filter head cross section 211 taking place along the second axis 420, which is represented in FIG. 2c, in each case a swirled flow 140 is represented by means of an elliptical, closed arrow. The swirled flows 140 in each case rotate about an axis of rotation parallel to the third axis 430—represented for example in FIG. 1b.

A method according to the invention for cleaning a filter module 100 is represented schematically in FIG. 1b as a sectional view in a plane spanned by the first axis 410 and the third axis 430. Three filter modules 200 are represented, which each have two filter heads 210 and one filtrate area 220, wherein in each case the two filter heads 210 are connected to the filtrate area 220. The fluid 110 is first divided. Then one portion of the fluid 110 is channelled into the first filter head 210 of the first filter module 200 and another portion of the fluid 110 is channelled into the second filter head 210 of the first filter module 200. A respectively further portion of the fluid 110 is respectively channelled from the first filter head 210 and the second filter head 210 of the first filter module 200 respectively to the first filter head 210 and the second filter head 210 of the second filter module 200 and then channelled respectively to the first filter head 210 and the second filter head 210 of the third filter module 200. From the filter heads 210 of the first filter module 200, second filter module 200 and third filter module 200, in each case another further portion of the fluid 110 is channelled into the filtrate area 220. The other further portions of the fluid 110 are then in each case channelled together into the filtrate areas 220 and channelled out of the filtrate areas 220. The other further portions of the fluid 110 channelled out of the filtrate areas 220 are channelled together as filtrate 120 outside the filter modules 200 and then fed to the start of the method again as recirculation 150. The first filter heads 210 can be the filter heads 210 lying at the top along the third axis 430. Thus, the filter heads 210 lying at the bottom along the third axis 430 would be the second filter heads 210. However, the opposite is also possible.

A filter head 210 of the filter module arrangement 300 represented in FIG. 1a is represented schematically in FIG. 2a as a sectional view in a plane spanned by the first axis 410 and the second axis 420. Flow lines are likewise represented, which, along the first axis 410, first enter the filter head 210 via a first filter head opening 212 and then exit the filter head 210 substantially via a second filter head opening 212. The swirled flows 140 already represented in FIG. 1a are likewise represented in FIG. 2a.

The filter head 210 represented in FIG. 2a is represented in FIG. 2b. In addition, two filter head parts 214 are represented, which are separated from each other in a fluid-impermeable manner. The swirled flows 140 already represented in FIG. 2a remain substantially unaffected by the separation of the filter head 210, whereas the main flow 130 is weakened by the reduction in size of the flow area, which is represented by a correspondingly reduced number of flow arrows.

The filter head 210 represented in FIG. 2a is represented in FIG. 2c. Along the first axis 410 five filter head cross sections 211 are represented in succession, which represent internal dimensions parallel to the second axis 420 in the plane spanned by the first axis 410 and the second axis 420. Along the first axis 410 the filter head cross section 211 first gets smaller in order then to get bigger. A larger third filter head cross section 211 than at the first end of the filter head 210 along the first axis 410 is achieved in the process. The filter head cross section 211 then gets smaller again and finally gets bigger again. The first and last filter head cross sections 211 and the second and fourth filter head cross sections 211 are the same size in each case.

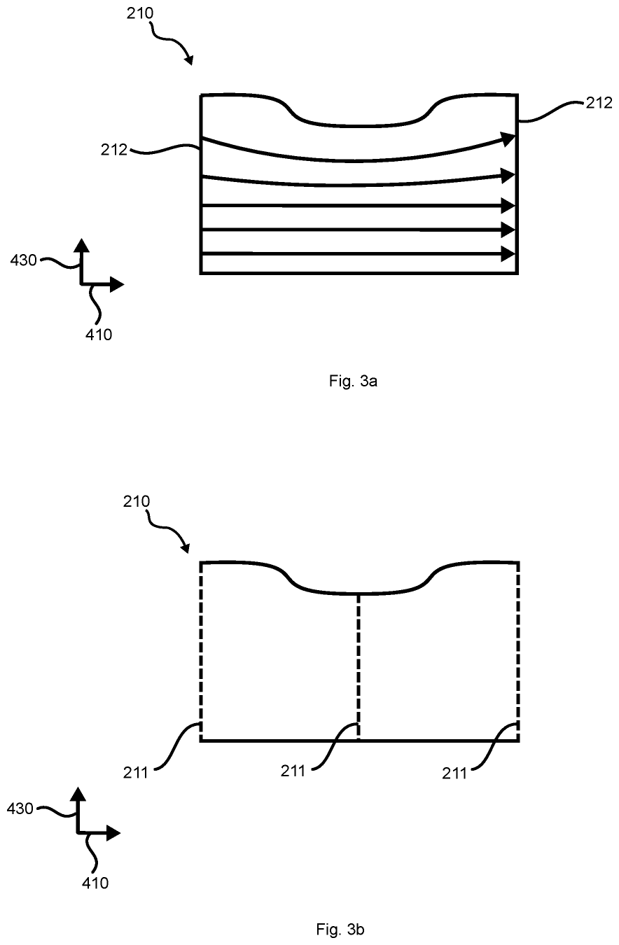

A filter head 210 is represented schematically in FIG. 3a as a sectional view in a plane spanned by the first axis 410 and the third axis 430. Along the first axis 410 the filter head 210 first gets smaller along the third axis 430 and then gets bigger again, which is represented in FIG. 3b by three corresponding filter head cross sections 211. The reduction in size and the increase in size in each case take place in the area of the filter head 210 lying at the top with respect to the third axis 430 and in each case run substantially elliptically. The flow lines start at the first filter head opening 212 along the first axis 410 and extend up to the second filter head opening 212 along the first axis 410. In the upper area, with respect to the third axis 430, of the filter head 210 the flow lines follow the outer edge of the filter head 210, thus are correspondingly bulged downwards in relation to the third axis 430. This deflection of the flow lines from a straight line is weakened downwards with respect to the third axis 430.

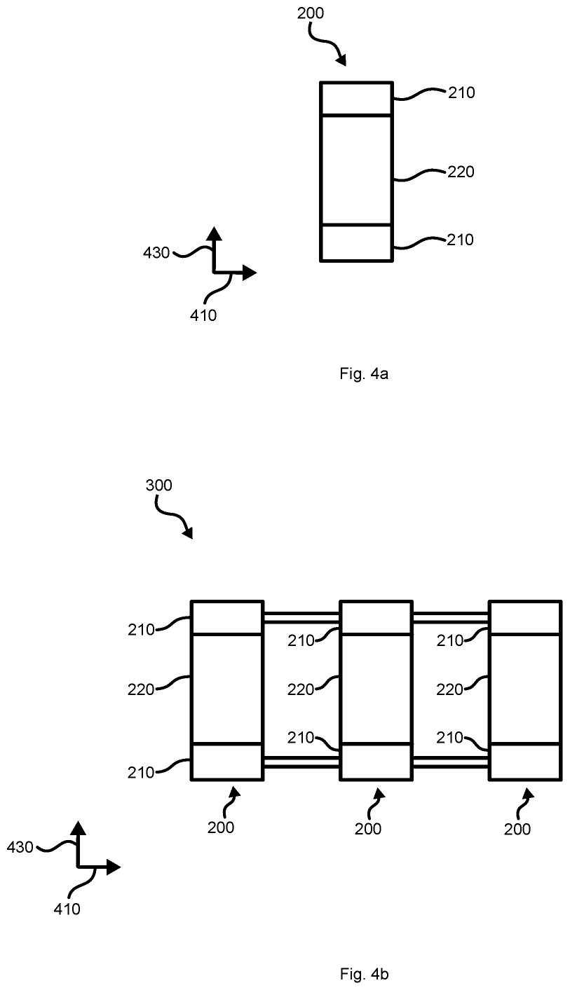

A filter module 200 according to the invention is represented schematically in FIG. 4a in a plane spanned by the first axis 410 and the third axis 430. The filter module 200 has two filter heads 210, which are each connected to a filtrate area 220.

A filter module arrangement 300 according to the invention is represented schematically in FIG. 4b in a plane spanned by the first axis 410 and the third axis 430. It consists of three filter modules 200—as represented in FIG. 4a and arranged one behind another along the first axis 410. The head areas 210 of the first filter module 200 are each connected to the head areas 210 of the second filter module 200. In addition, the head areas 210 of the second filter module 200 are also each connected to the head areas 210 of the third filter module 200. The method represented in FIG. 1b for cleaning a filter module 100 can be carried out with the filter module arrangement 300 represented in FIG. 4b.

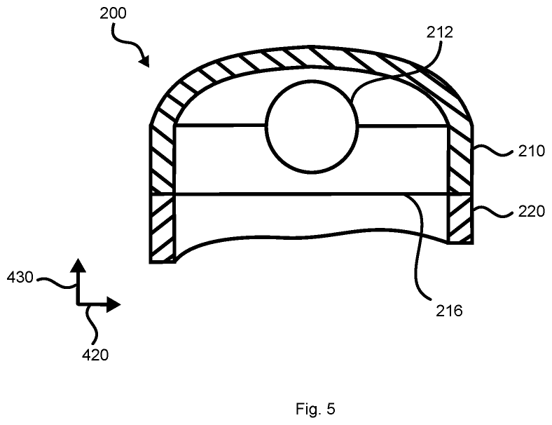

A filter head 210 of a filter module 200 according to the invention is represented schematically in FIG. 5 as a sectional view in a plane spanned by the second axis 420 and the third axis 430. The filter head 210 has an opening 216 at the end located at the bottom along the third axis 430. The opening 216 extends completely over the end of the filter head 210 which is lower with respect to the third axis 430 and spanned by the second axis 420. A circular filter head opening 212 arranged in the centre with respect to the second axis 420 is furthermore represented.

Although at least one preferred embodiment has been presented in the preceding description of the preferred embodiments, there are a large number of variations. The preferred embodiments are only examples and do not serve to limit the scope of protection, the applicability or the precise design. Instead the presentation of the invention and the description of the preferred embodiments provide a person skilled in the art with useful directions for implementing at least one embodiment. Various changes can be made to the form and function of the described features without departing from the scope of protection of the claims and their equivalents.

### LIST OF REFERENCE NUMBERS

100 method for cleaning a filter module
110 fluid
120 filtrate
130 main flow
140 swirled flow
150 recirculation
200 filter module
210 filter head
211 filter head cross section
212 filter head opening
214 filter head part
216 opening
220 filtrate area
300 filter module arrangement
410 first axis
420 second axis
430 third axis

1. A method for cleaning a filter module by means of a filter module having the following steps:
(i) providing a filter module having a filter head with two filter head openings;
(ii) channelling fluid into the filter head via a first filter head opening; and
(iii) channelling a portion of the fluid out of the filter head via a second filter head opening,
wherein, after step (ii), the fluid is partially swirled in the filter head.

2. The method according to claim 1, wherein the filter module furthermore has a filtrate area and, before step (iii), another portion of the fluid is channelled from the filter head into the filtrate area.

3. The method according to claim 1, wherein after step (ii) and before the fluid is swirled in the filter head, the fluid is accelerated along a path connecting the filter head openings.

4. The method according to claim 1, wherein the filter head furthermore has two filter head parts separated from each other in a fluid-impermeable manner and,
during step (ii), fluid is channelled both into a first filter head part and into a second filter head part.

5. The method according to claim 1, wherein the filter module furthermore has a second filter head with two filter head openings,
during step (ii), fluid is channelled into the second filter head via a first filter head opening of the second filter head,
after step (ii), the fluid is partially swirled in the second filter head and,
during step (iii), a portion of the fluid is channelled out of the second filter head via a second filter head opening of the second filter head.

6. The method according to claim 1, wherein the portion of the fluid channelled out of a filter head during step (iii) is fed to step (ii) again after step (iii).

7. The method according to claim 6, wherein during step (i), a second filter module having a filter head with two filter head openings is provided,
after step (iii), the fluid channelled out of a filter head of the first filter module is channelled into the filter head of the second filter module via a first filter head opening of the filter head of the second filter module, then the fluid is partially swirled in the filter head of the second filter module, and
a portion of the fluid is then channelled out of the filter head of the second filter module via a second filter head opening of the filter head of the second filter module.

8. The method according to claim 7, wherein after it has been channelled out of the filter head of the second filter module, the fluid is fed to step (ii) again.

9. The method according to claim 5, wherein the second filter module furthermore has a second filter head with two filter head openings,
after step (iii), the fluid channelled out of a filter head of the first filter module is channelled into the second filter head of the second filter module via a first filter head opening of the second filter head of the second filter module,
then the fluid is partially swirled in the second filter head of the second filter module,
a portion of the fluid is then channelled out of the second filter head of the second filter module via a second filter head opening of the second filter head of the second filter module and,
after it has been channelled out of the second filter head of the second filter module, the fluid is then fed to step (ii) again.

10. A filter module having a filter head with two filter head openings, wherein
a first filter head opening and a second filter head opening are arranged one behind another along a first axis, wherein the first axis runs through the centre of the first filter head opening and through the centre of the second filter head opening,
an inner filter head cross section located perpendicular to the first axis along the first axis starting from the first filter head opening first gets bigger along a second axis and then gets smaller up to the second filter head opening along the second axis, wherein the second axis is aligned perpendicular to the first axis,
at its ends located along the second axis and at a first of its two ends located along a third axis the filter head is closed, wherein the third axis is aligned simultaneously perpendicular to the first axis and perpendicular to the second axis, and
at a second of its ends located along the third axis the filter head has an opening.

11. The filter module according to claim 10, wherein the inner edge of the filter head runs partially elliptically in the plane spanned by the first axis and the second axis.

12. The filter module according to claim 10, wherein the filter head cross section along the first axis first gets smaller along the second axis before its increase in size taking place along the second axis.

13. The filter module according to claim 12, wherein the inner edge of the filter head runs partially elliptically in the plane spanned by the first axis and the second axis in the area of the reduction in size, which takes place before the increase in size taking place along the second axis.

14. The filter module according to claim 10 the filter head cross section along the first axis starting from the first filter head opening first gets smaller along the third axis and then gets bigger up to the second filter head opening along the third axis.

15. The filter module according to claim 14, wherein the inner edge of the filter head runs partially elliptically in the area of the reduction in size taking place along the third axis.

16. The filter module according to claim 10, wherein the filter head furthermore has two filter head parts,
wherein the filter head parts each extend from the first filter head opening up to the second filter head opening,
and the filter head parts are separated from each other in a fluid-impermeable manner along the first axis between the first filter head opening and the second filter head opening.

17. The filter module according to claim 10, wherein the filter module furthermore has a filtrate area, wherein the filtrate area is connected to the filter head at the second end of the filter head located along the third axis.

18. The filter module according to claim 17, wherein the filter module furthermore has a second filter head equivalent to the first filter head, wherein the filtrate area is connected to the second filter head at the second end of the second filter head located along the third axis.

19. The filter module according to claim 10, wherein the closed end of the filter head is formed dome-shaped along the third axis.

20. A filter module arrangement consisting of at least two filter modules according to claim 10, wherein the filter modules are arranged one behind another and connected to each other such that fluid can be channelled first into a filter head of a first filter module and then into a filter head of a second to n-th filter module.
